(19) United States
(12) Patent Application Publication
(10) Pub. No.: US 2026/0359495 A1
(43) Pub. Date: Nov. 12, 2026

(54) DIGITAL KEY FRAMEWORK FOR PROCESSING COMMANDS

(71) Applicant: Google LLC, Mountain View, CA (US)

(72) Inventors: Adam M. Bar-Niv, Los Altos, CA (US); Shiv Rajora, Mountain View, CA (US); Baktash Boghrati, San Francisco, CA (US)

(21) Appl. No.: 19/490,692

(22) PCT Filed: Jun. 30, 2023
(86) PCT No.: PCT/US2023/026742

§ 371 Date: Dec. 5, 2025

(51) Int. Cl. G06F 21/74; G06F 1/3206; G06F 1/3287

(52) U.S. Cl. CPC G06F 21/74; G06F 1/3206; G06F 1/3287

(57) ABSTRACT

A secure element of a computing device may receive commands from a vehicle. The secure element may determine whether the secure element can process the commands while an application processor of the computing device is operating in a low-power state based on at least one of a transaction type or a transaction configuration of the secure element. Responsive to determining that the secure element can process the command while the application processor is operating in a low-power state, the secure element may process (e.g., filter) the command while the application processor is operating in the low-power state to reduce the overall power consumption of the device.

### BACKGROUND

A computing device may use digital key technology to operate functionality of a vehicle (e.g., lock and unlock the vehicle's doors, start the engine, open the trunk, etc.). In some examples, the computing device may implement the digital key technology by communicating with the vehicle using a wireless communication technology, such as near field communication (NFC), Bluetooth, or ultra-wide band (UWB). Digital key technology may enable the user of a vehicle to leave the physical key for the vehicle in a secure location (e.g., at home) because the digital key stored in the computing device provides the same or similar functionality.

### SUMMARY

Techniques are described by which a computing device may implement a digital key framework that processes commands from a vehicle to, for example, reduce unnecessary power consumption. For example, a secure element of a computing device may determine whether to discard a command based on one or more factors including a transaction type, a transaction configuration of the secure element, etc. Based on the determination, the secure element may discard the command without “waking up” other components of the computing device (which otherwise may entail activating, e.g., the application processor of the computing device, the operating system of the computing device, the display of the computing device, etc.). In this way, the techniques of this disclosure may reduce consumption of resources (e.g., battery power, processor cycles, etc.).

In some examples, a method includes receiving, by a secure element of a computing device, a command from a vehicle, and determining, by the secure element, whether the secure element can process the command while an application processor of the computing device is operating in a low-power state based on at least one of a transaction type or a transaction configuration of the secure element. The method may also include, responsive to determining that the secure element can process the command while the application processor is operating in the low-power state, processing, by the secure element, the command while the application processor is operating in the low-power state.

In some examples, a computing device includes an application processor and a secure element. The secure element is configured to receive, from a vehicle communicatively coupled to the computing device, a command and determine, based on at least one of a transaction type or a transaction configuration of the secure element, whether the secure element can process the command while the application processor is operating in a low-power state. Responsive to determining that the secure element can process the command while the application processor is operating in the low-power state, the secure element is configured to process the command while the application processor is operating in the low-power state. Responsive to determining that the secure element cannot process the command while the application processor is operating in the low-power state, the secure element is configured to cause the application processor to switch from operating in the low-power state to operating in a high-power state and send, to the application processor, at least an indication of the command.

In some examples, a computer-readable storage medium includes instructions that, when executed, cause one or more processors of a computing device to receive, by one or more secure elements, a command from a vehicle. The instructions further cause the one or more processors to determine, by the one or more secure elements, whether the one or more secure elements can process the command while one or more application processors are operating in a low-power state based on at least one of a transaction type or a transaction configuration of the one or more secure elements. Responsive to the one or more processors determining that the one or more secure elements can process the command while the one or more application processors are operating in the low-power state, the instructions further cause the one or more processors to process, by the one or more secure elements, the command while the one or more application processors are operating in the low-power state.

The details of one or more examples are set forth in the accompanying drawings and the description below. Other features, objects, and advantages of the disclosure will be apparent from the description and drawings, and from the claims.

### BRIEF DESCRIPTION OF DRAWINGS

FIG. 1 is a conceptual diagram illustrating an example system configured to implement a digital key framework that processes commands from a vehicle in accordance with techniques of this disclosure.

FIG. 2 is a block diagram illustrating an example computing device configured to implement a digital key framework that processes commands from a vehicle in accordance with techniques of this disclosure.

FIG. 3 is a flowchart illustrating exemplary operation of a computing device configured to implement a digital key framework that processes commands from a vehicle in accordance with techniques of this disclosure.

### DETAILED DESCRIPTION

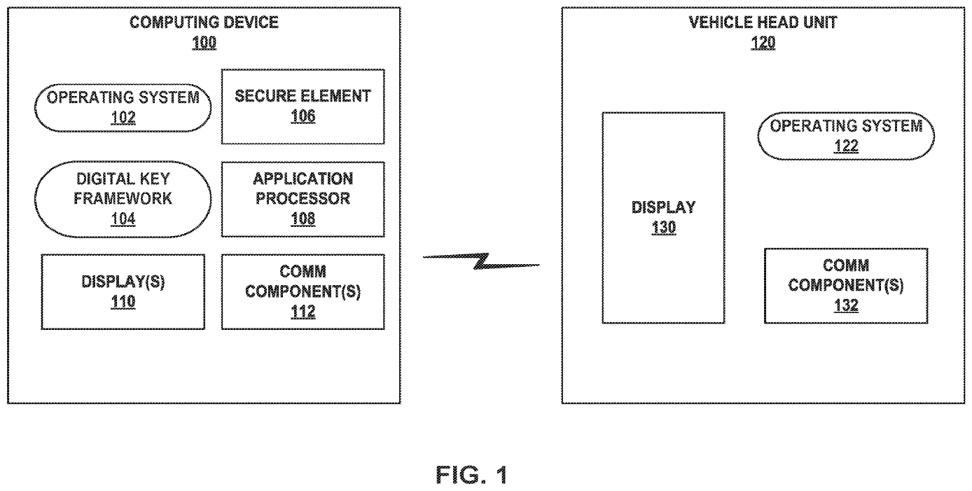

FIG. 1 is a conceptual diagram illustrating an example system configured to implement a digital key framework that processes commands from a vehicle in accordance with techniques of this disclosure. As shown in the example of FIG. 1, a system may include a mobile computing device 100 (“computing device 100”) and a vehicle head unit 120.

In the example of FIG. 1, computing device 100 is a smartphone. However, other examples of computing device 100 may be a laptop computer, a tablet computer, a portable gaming device, a portable media player, an e-book reader, a watch (including a so-called smartwatch), an add-on device (such as a casting device), smart glasses, a gaming controller, or another type of portable or mobile device.

Computing device 100 may include an operating system 102 (“OS 102”) that provides an execution environment for one or more applications, such as a digital key framework 104. OS 102 may represent a multi-threaded operating system or a single-threaded operating system with which digital key framework 104 may interface to access hardware of computing device 100. OS 102 may include a kernel that facilitates access to the underlying hardware of computing device 100, where kernel may present a number of different interfaces (e.g., application programmer interfaces) that applications may invoke to access the underlying hardware of computing device 100.

Examples of the underlying hardware of computing device 100 includes one or more processors, such as secure element 106 and application processor 108. The processors may support execution of OS 102 and digital key framework 104. In general, secure element 106 may be configured to store and process sensitive information, such as cryptographic keys and other sensitive data. On the other hand, application processor 108 may be configured to execute more complex tasks, such as running OS 102, applications, and other functions such as camera, audio, voice recognition, and data connectivity. In some examples, OS 102 may manage which tasks are assigned to secure element 106 and application processor 108 (e.g., depending on the workload demand).

Secure element 106 may be configured to store and process sensitive information, such as confidential and cryptographic data. For example, secure element 106 may include hardware-based security features, such as secure boot, cryptographic acceleration, and tamper-resistant storage, which may help to protect sensitive information and prevent unauthorized access (e.g., secure element 106 may only run a limited set of applications). Secure element 106 may include one or more low-power cores that are configured to be low-power and thermally efficient. Low-power cores may be particularly suitable for reducing power draw and the risk of thermal stress, factors that can potentially compromise the security of computing device 100 (e.g., by resulting in insufficient power to perform critical operations, damaging hardware components due to thermal expansion and contraction, etc.). In some examples, secure element 106 may include a reduced instruction set computer (RISC) core cadenced at about 60 megahertz (MHz).

Secure element 106 may be at least partially isolated from the rest of the hardware and software of computing device 100. For example, secure element 106 may be a separate processing circuitry that is physically isolated from application processor 108. In addition, secure element 106 may be isolated from OS 102 in that secure element 106 may operate in a separate environment designed to protect the sensitive information stored on secure element 106 from unauthorized access or manipulation.

For example, secure element 106 may have a separate boot process and run firmware that is separate from OS 102. This separation may ensure that sensitive information stored in secure element 106 is protected from malicious software or attacks on OS 102. In some examples, the firmware of secure element 106 may represent a secure interface with which OS 102 may interact. For example, OS 102 may interface with the firmware to request access to information stored in secure element 106, and secure element 106 may determine whether to grant or deny the request.

Application processor 108 may be configured to run software applications on computing device 100. For example, application processor 108 may process and execute tasks and commands within OS 102, as well as run third-party applications. Application processor 108 may include one or more high-power cores to provide high-performance computing capabilities for computing device 100. Application processor 108 may also include one or more low-power cores to improve energy efficiency. The low-power cores of application processor 108 may be substantially similar to the low-power cores of secure element 106. In general, high-power cores and low-power cores may differ in various respects (e.g., processing power, energy consumption, thermal characteristics, etc.). For example, compared to low-power cores, high-power cores may have higher clock speeds, more complex architectures, and consume more power. For example, high-power cores may have a processing speed of about 3 GHz, while low-power cores may have a processing speed of about 2 GHz.

Application processor 108 may be configured to switch between operating in a low-power state (e.g., a “power saving mode” or a “sleep mode”) and operating in a high-power state (e.g., a “high-performance mode” or a “turbo mode”). In some examples, when application processor 108 is operating in a low-power state, application processor 108 may reduce clock frequency and voltage to decrease power consumption. In some examples, when application processor 108 is operating in a high-power state, application processor 108 may increase clock frequency and voltage to enable higher levels of performance. When in the high-power state, application processor 108 may consume more power but be able to perform a larger range of tasks and perform tasks more quickly.

In any case, the cores of secure element 106 and the cores of application processor 108 may be on the same die (e.g., a rectangular pattern on a wafer containing circuitry). In other words, secure element 106 and application processor 108 may represent a heterogeneous computing architecture where different cores with different processing power and energy efficiency are paired within a system on a chip (SoC).

Computing device 100 may include one or more displays 110 (“display 110”). Display 110 of computing device 100 may represent a presence-sensitive display that functions as an input device and as an output device. Display 110 may be implemented using various display hardware. For instance, display 110 may function as an input device using a presence-sensitive input component, such as a resistive touchscreen, a surface acoustic wave touchscreen, a capacitive touchscreen, a projective capacitance touchscreen, a pressure sensitive screen, an acoustic pulse recognition touchscreen, or another presence-sensitive display technology. Display 110 may function as an output (e.g., display) device using any one or more display components, such as a liquid crystal display (LCD), dot matrix display, light emitting diode (LED) display, organic light-emitting diode (OLED) display, e-ink, or similar monochrome or color display capable of outputting visible information to a user of computing device 100.

Computing device 100 may include one or more communication components, such as communication components 112A-112N (“COMM components 112”) . COMM components 112 may include wireless communication devices capable of transmitting and/or receiving communication signals such as a cellular radio, a 3G radio, a 4G radio, a 5G radio, an ultra-wide bandwidth (UWB) radio, a Bluetooth® radio (or any other PAN radio), an NFC radio, or a Wi-Fi™ radio (or any other WLAN radio). Additionally or alternatively, COMM components 112 may include wired communication devices capable of transmitting and/or receiving communication signals via a direct link over a wired communication medium (e.g., a universal serial bus cable).

OS 102 and/or digital key framework 104 may present a GUI with which a user of computing device 100 may interface to interact with computing device 100. OS 102 may present, via display 110, a GUI that includes one or more icons or other visual representations of digital key framework 104, where the user of computing device 100 may select one or more of the icons or other visual representations to access various services provided by computing device 100 either by way of OS 102 or by way of digital key framework 104.

Vehicle head unit 120 may control various functions of the vehicle in which vehicle head unit 120 is integrated. For example, vehicle head unit 120 may control settings, such as turning lights on or off or locking and unlocking the doors. In some examples, vehicle head unit 120 may present an interface (e.g., a graphical user interface (GUI)) by which to control vehicle systems, such as a heating, ventilation, and air conditioning (HVAC) system, a lighting system (for controlling interior and/or exterior lights), an infotainment system, a seating system (for controlling a position of a driver and/or passenger seat), etc. The interface may be presented via a console (e.g., an in-vehicle display). Vehicle head unit 120 may be included in a motorcycle, a bus, a recreational vehicle (RV), a semi-trailer truck, a tractor or other type of farm equipment, a train, a plane, a drone, a helicopter, a personal transport vehicle, etc.

Vehicle head unit 120 may include an OS 122 (“OS 122”), which may be similar or substantially similar to OS 102 in that OS 122 may present an execution environment in which one or more applications may execute to extend functionality of (or, in other words, services provided by) vehicle head unit 120. OS 122 may include integrated first party applications that provide services similar to those discussed above with respect to the integrated applications of OS 102.

In any event, OS 122 may present interfaces by which the applications may interface with underlying hardware of vehicle head unit 120. The underlying hardware of vehicle head unit 120 may include one or more processors (not shown for ease of illustration) that are configured to execute OS 122 and the one or more applications, display 130, and one or more communication components 128 (“COMM components 128”).

Display 130 may be similar to display 110, where display 130 may, similar to display 110, represent a presence-sensitive display. That is, similar to display 110 of computing device 100, display 130 may function as an input and as an output device. Moreover, similar to COMM components 112 of computing device 100, COMM components 132 may include wireless and wired communication interfaces capable of transmitting and/or receiving communication signals such as a cellular radio, a 3G radio, a 4G radio, a 5G radio, a Bluetooth® radio (or any other type of PAN radio), a Wi-Fi™ radio (or any other type of WLAN radio), ethernet, USB, etc.

In general, digital key technology can be convenient for the user of a vehicle. For example, a digital key may allow the user to unlock and start a vehicle without using a physical key. Computing device 100 may store the digital key, eliminating the need for a physical key and potentially reducing the risk of losing the physical key. That said, digital key technology may excessively consume resources (e.g., battery power) of computing device 100. For example, vehicle head unit 120 may periodically ping (e.g., send commands to) computing device 100 to confirm if computing device 100 (which stores the digital key) is still in or otherwise near the vehicle. This pinging may cause computing device 100 to “wake up” or activate application processor 108 to output (e.g., for display) the commands, resulting in increased power consumption. However, outputting the command may be unnecessary (e.g., when the command does not actually require user attention).

In accordance with techniques of this disclosure, secure element 106 of computing device 100 may determine whether to discard a command while application processor 108 is operating in a low-power state or output, by application processor 108 and for display, the command. For example, secure element 106 may determine to discard commands based on at least one of a transaction type or a transaction configuration of secure element 106. Based on the determination, secure element 106 may discard the command.

Secure element 106 may be configured to communicate with vehicle head unit 120 via a wireless transport while application processor 108 is operating in a low-power state. For example, when vehicle head unit 120 sends a command to computing device 100, secure element 106 may receive the command while application processor 108 is operating in a low-power state.

Secure element 106 may process the command based on various factors described herein. That said, in general, whenever responding to a command does not require activating application processor 108, secure element 106 may respond to the command without activating application processor 108 to avoid increasing power consumption. In other words, secure element 106 may only activate application processor 108 when necessary to respond to the command.

Secure element 106 may process a command while application processor 108 is operating in a low-power state. Example ways secure element 106 can process a command may include filtering the commands, managing the outputting of the command (e.g., when to output the command), discarding the command, responding to a request associated with the command, requesting information from the source of the command, etc. Thus, although processing, by secure element 106, a command is primarily described herein as discarding the command, discarding a command is simply an example provided for purposes of explanation, and other ways of processing a command are contemplated by this disclosure.

In some examples, secure element 106 may process a command based on a transaction type (e.g., a code, label, identifier, etc.). A transaction type may indicate whether the attention of the user is required, the reason for the command, whether the command includes a request for information (e.g., the digital key), etc. For example, a first transaction type may be associated with a command for unlocking doors of a vehicle; a second transaction type may be associated with a command for locking doors of a vehicle; a third transaction type may be associated with a command for confirming the presence of computing device 100 within or near the vehicle.

Secure element 106 may process the command based on a transaction configuration of secure element 106. A user of computing device 100 may customize, reconfigure, or otherwise modify the transaction configuration of secure element 106 in accordance with the user's preferences. The transaction configuration may include options, preferences, settings, etc., that control how secure element 106 processes a command (e.g., discarding the command, sending the command to application processor 108, etc.). For example, secure element 106 may determine, based on the transaction configuration, which transaction types to discard, which transaction types to output, how the commands are output, the frequency and timing of commands, etc.

For example, based on the transaction configuration, secure element 106 may determine to output, by application processor 108 and for display, a first transaction type associated with a command for unlocking doors of a vehicle. Additionally or alternatively, based on the transaction configuration, secure element 106 may determine to discard a second transaction type associated with a command for locking doors of a vehicle as well as a third transaction type associated with a command for confirming the presence of computing device 100 within or near the vehicle.

Based on whether secure element 106 can process the command while application processor 108 is operating in a low-power state, secure element 106 may process the command or cause application processor 108 to switch from operating in a low-power state to a high-power state. For example, responsive to determining that the command from vehicle head unit 120 is to be discarded (e.g., based on the transaction type and/or the transaction configuration of secure element 106), which secure element 106 can perform while application processor 108 is operating in a low-power state, secure element 106 may discard the command while application processor 108 is operating in a low-power state. In another example, responsive to determining that the command from vehicle head unit 120 is to be outputted for display, which secure element 106 cannot perform while application processor 108 is operating in a low-power state, secure element 106 may cause application processor 108 to be activated such that application processor 108 is operating in a high-power state. Application processor 108 may then output, for display, the command. Secure element 106 may also send application processor 108 at least an indication of the command.

In this way, the techniques of this disclosure may advantageously process (e.g., filter) commands that otherwise may needlessly increase power consumption of computing device 100. For example, when a user of computing device 100 approaches the user's vehicle, secure element 106 may discard a command from vehicle head unit 120 indicating that the user's vehicle is nearby. When the user unlocks the vehicle, secure element 106 may activate application processor 108 to output a command that the user's vehicle has been unlocked. When the user starts the engine of the vehicle, secure element 106 may activate application processor 108 to output a command that the user's vehicle has been started. When the user is driving the vehicle, secure element 106 may discard all commands for confirming the presence of computing device 100 within or near the vehicle.

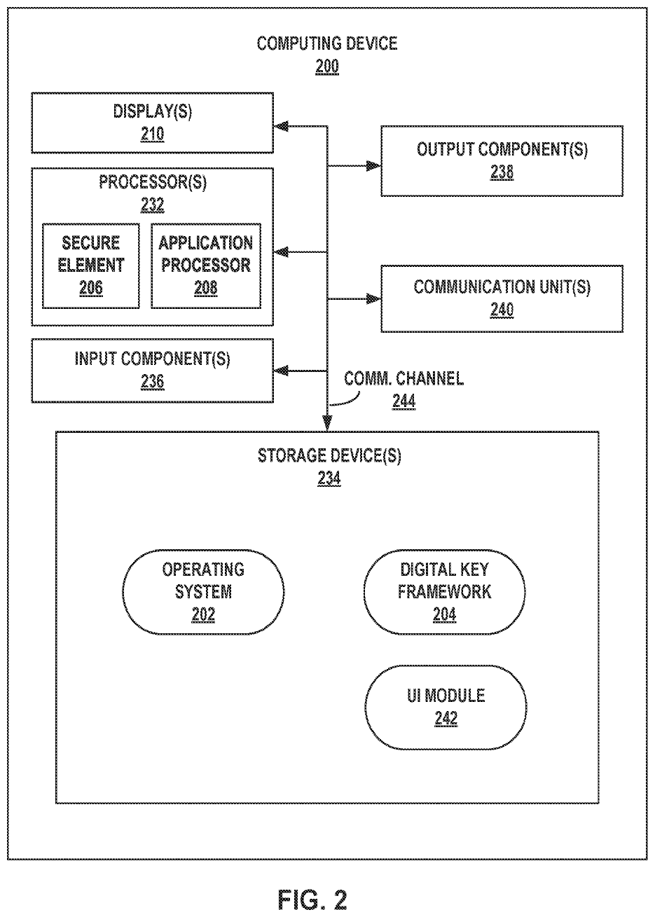

FIG. 2 is a block diagram illustrating an example computing device 200 configured to implement a digital key framework that processes commands from a vehicle in accordance with techniques of this disclosure. Computing device 200 shown in the example of FIG. 2 is one example of computing device 100 shown in FIG. 1. FIG. 2 illustrates only one particular example of computing device 200, and many other examples of computing device 200 may be used in other instances and may include a subset of the components included in example computing device 200 or may include additional components not shown in FIG. 2.

As shown in FIG. 2, computing device 200 may include one or more displays 210 (“display 210”), one or more processors 232 (“processor 232”), one or more storage devices 234 (“storage device 234”), one or more input components 236 (“input component 236”), one or more output components 238 (output component 238”) and one or more communication units 240 (“communication unit 240”). As also shown in FIG. 2, storage device 234 may include an operating system 202 (“OS 202”), a digital key framework 204, and a user interface module 242 (“UI module 242”).

Display 210 may detect input (e.g., touch and non-touch input) from a user of respective computing device 200. For instance, display 210 may detect indications of input by detecting one or more gestures from a user (e.g., the user touching, pointing, and/or swiping at or near one or more locations of display 210 with a finger, stylus pen, or another user input element). Display 210 may output information to a user in the form of a user interface (UI), which may be associated with functionality provided by computing device 200. Such UIs may be associated with computing platforms, operating systems, applications, and/or services executing at or accessible from computing device 200 (e.g., electronic message applications, chat applications, Internet browser applications, mobile or desktop operating systems, social media applications, electronic games, menus, and other types of applications).

Processor 232 may implement functionality and/or execute instructions within computing device 200. For example, processor 232 may receive and execute instructions that provide the functionality described herein. These instructions executed by processor 232 may cause computing device 200 to store and/or modify information within storage device 234 of processor 232 during program execution. Processor 232 may execute instructions of OS 202, digital key framework 204, and UI module 242 to perform one or more operations. That is OS 202, digital key framework 204, and UI module 242 may be operable by processor 232 to perform various functions described herein.

Storage device 234 within computing device 200 may store information for processing during operation of computing device 200 (e.g., computing device 200 may store data accessed by OS 202, digital key framework 204, and UI module 242 during execution at computing device 200). In some examples, storage device 234 may be a temporary memory, meaning that a primary purpose of storage device 234 is not long-term storage. Storage device 234 on computing device 200 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage device 234 may include one or more computer-readable storage media. Storage device 234 may be configured to store larger amounts of information than volatile memory. Storage device 234 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage device 234 may store program instructions and/or information associated with OS 202, digital key framework 204, and UI module 242.

Input component 236 of computing device 200 may receive input. Examples of input are tactile, audio, and video input. Input component 236 of computing device 200, in one example, includes a presence-sensitive display, such as display 210, a fingerprint sensor, touch-sensitive screen, mouse, keyboard, voice responsive system, video camera, microphone or any other type of device for detecting input from a human or machine.

Input component 236 may include one or more sensors. Numerous examples of sensors exist and include any input component configured to obtain environmental information about the circumstances surrounding computing device 200 and/or physiological information that defines the activity state and/or physical well-being of a user of computing device 200. In some examples, a sensor may be an input component that obtains physical position, movement, and/or location information of computing device 200. For instance, sensors may include one or more location sensors (e.g., GNSS components, Wi-Fi components, cellular components), one or more temperature sensors, one or more motion sensors (e.g., multi-axial accelerometers, gyros), one or more pressure sensors (e.g., barometer), one or more ambient light sensors, and one or more other sensors (e.g., microphone, camera, infrared proximity sensor, hygrometer, and the like). Other sensors may include a heart rate sensor, magnetometer, glucose sensor, hygrometer sensor, olfactory sensor, compass sensor, step counter sensor, to name a few other non-limiting examples.

Output component 238 of computing device 200 may generate one or more outputs. Examples of outputs are tactile, audio, and video output. Output component 238 of computing device 200, in one example, includes a presence-sensitive display, sound card, video graphics adapter card, speaker, liquid crystal display (LCD), or any other type of device for generating output to a human or machine.

Communication unit 240 of computing device 200 may communicate with one or more external devices via one or more wired and/or wireless networks by transmitting and/or receiving network signals on the one or more networks. Examples of communication units 240 include a network interface card (e.g. such as an Ethernet card), an optical transceiver, a radio frequency transceiver, a GPS receiver, or any other type of device that can send and/or receive information. Other examples of communication unit 240 may include short wave radios, cellular data radios, wireless network radios, as well as universal serial bus (USB) controllers.

Communication channels 244 (“COMM channel 244”) may interconnect each of the components 210, 232, 234, 236, 238, and 240 for inter-component communications (physically, communicatively, and/or operatively). In some examples, communication channels 244 may include a system bus, a network connection, an inter-process communication data structure, or any other method for communicating data.

OS 202, or a component thereof, may manage interactions between software applications and a user of computing device 200. OS 202 may have a kernel that facilitates interactions with underlying hardware of computing device 100 and provides a fully formed application space capable of executing a wide variety of software applications having secure partitions in which each of the software applications executes to perform various operations. In some examples, UI module 242 may be considered a component of OS 202.

UI module 242 may manage user interactions with display 210 and other components of computing device 200. For example, UI module 242 may output a UI, such as a GUI, and may cause display 210 to display the UI as a user of computing device 200 views output and/or provides input at display 210 or other components of computing device 200.

As noted above, secure element 206 may process a command based on a transaction type and transaction configuration of secure element 206. In some examples, a user of computing device 200 may wish to customize the transaction configuration based on their circumstances. For example, if the user of computing device 200 wants to avoid all distractions, the user of computing device 200 may prefer that secure element 206 only activates application processor 208 in response to urgent commands. In another example, if the user of computing device 200 wants to preserve the battery power of computing device 200 (e.g., because the battery power is low), the user of computing device 200 may prefer that secure element 206 only activates application processor 208 in response to urgent commands.

In accordance with techniques of this disclosure, the transaction configuration of secure element 206 may control how secure element 206 processes a command based on a command setting associated with a mode (e.g., silent mode, vibrate mode, battery saver mode, etc.) of computing device 200. For example, based on the command setting associated with a mode of computing device 200, secure element 206 may determine to output, by application processor 208 and for display, all transaction types when computing device 200 is in a standard or regular mode, but discard specific transaction types when computing device 200 is in battery saver mode (e.g., to reduce power consumption) or a do not disturb mode (e.g., to avoid distractions). In general, a user may customize the transaction configuration of secure element 206, as well as the command settings associated with modes of computing device 200, as desired to suit the user's preferences.

In some examples, the transaction configuration may control how secure element 206 processes a command based on a command setting associated with an orientation of computing device 200. For example, based on the command setting associated with an orientation of computing device 200, secure element 206 may determine to discard a command when display 210 is facing downwards (e.g., when the normal vector of display 210 is pointing substantially vertically down). This transaction configuration may be based on the assumption that when display 210 is facing downwards, a user of computing device 200 is probably not looking at or otherwise using display 210 such that outputting a command for display would be a waste of energy.

Secure element 206 may determine the orientation of computing device 200 based on data from input component 236 (which may include, e.g., accelerometers, gyroscopes, etc.). For example, secure element 206 may monitor the orientation of computing device 200 with respect to gravity, allowing secure element 206 to determine if computing device 200 is oriented vertically or horizontally.

Processing a command based on an orientation of computing device 200 may be advantageous, for example, in the case of vehicles with a module (e.g., a reader module) that requires computing device 200 to have a particular orientation in order for the module to interface with computing device 200 (e.g., which may be a prerequisite for starting the vehicle). The user may not want computing device 200 to output the command in this scenario because the vehicle may indicate whether the prerequisite was satisfied in other ways (e.g., by starting or not the engine).

The transaction configuration of secure element 206 may include command settings other than the command setting associated with a mode of computing device 200 and the command setting associated with an orientation of computing device 200. For example, the transaction configuration may include a command setting associated with the frequency of commands, a command setting whether the command should be outputted in the form of audio, visual, and/or tactile stimuli, a command setting for automatically granting or denying a request associated with specific transaction types, etc. Thus, the examples provided herein are for purposes of explanation and are not intended to be limiting.

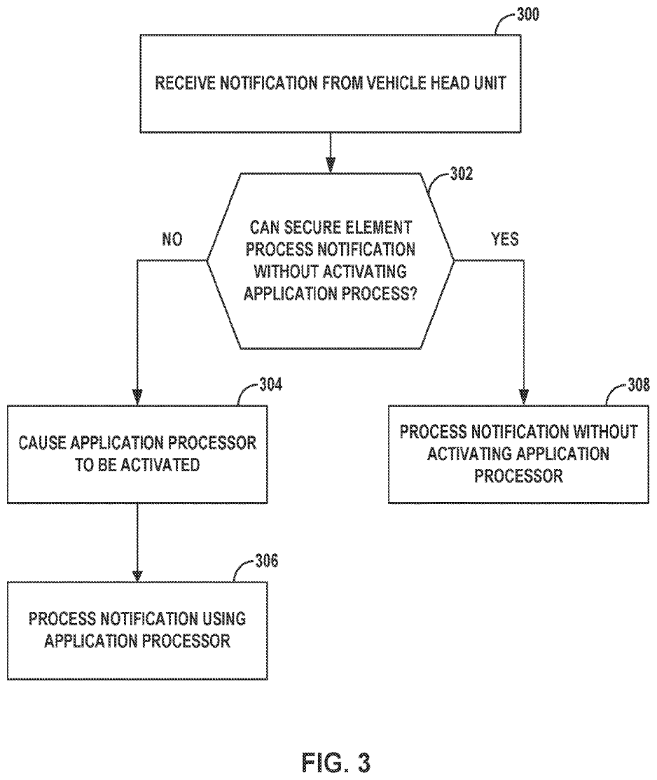

FIG. 3 is a flowchart illustrating example operations of an example computing device in accordance with techniques of this disclosure. Although the example operation of FIG. 3 is described as being performed by computing device 100 of FIG. 1, particularly secure element 106, in other examples some or all of the example operations may be performed by another computing device.

Secure element 106 of computing device 100 may receive, via COMM components 112, a command from vehicle head unit 120 (300). In accordance with techniques of this disclosure, instead of automatically outputting (e.g., for display) the command, which may cause application processor 108 to be activated and increase power consumption by computing device 100, secure element 106 may determine whether secure element 106 can process or otherwise respond to the command without activating application processor 108 (302). For example, secure element 106 may determine whether secure element 106 can discard the command.

Secure element 106 may process a command based on a transaction type. For example, each command from vehicle head unit 120 may have a transaction type, and secure element 106 may discard all commands having specific transaction types. Examples of transaction types may include a first transaction type associated with a command for unlocking doors of a vehicle, a second transaction type associated with a command for locking doors of a vehicle, and a third transaction type associated with a command for confirming the presence of computing device 100 within or near the vehicle. In some examples, transaction types may be associated with a frequency of a command (e.g., whether the command is a single event or recurring). A command for unlocking doors of a vehicle may have a single event transaction type. A command for confirming the presence of computing device 100 within or near the vehicle may have a recurring transaction type.

Secure element 106 may process the command based on a transaction configuration of secure element 106. The transaction configuration may include options, preferences, settings, etc., that control whether secure element 106 determines to discard or output (e.g., by application processor 108) a command. For example, secure element 106 may determine, based on the transaction configuration, which transaction types to discard, which transaction types to output, how the commands are output, the frequency and timing of commands, etc.

For example, based on the transaction configuration, secure element 106 may determine to output, by application processor 108 and for display, a first transaction type associated with a command for unlocking doors of a vehicle. Additionally or alternatively, based on the transaction configuration, secure element 106 may determine to discard a second transaction type associated with a command for locking doors of a vehicle as well as a third transaction type associated with a command for confirming the presence of computing device 100 within or near the vehicle. In yet another example, secure element 106 may determine not to discard all commands that have a single event transaction type, but to discard all commands that have a recurring transaction type.

In some examples, the transaction configuration may control how secure element 106 determines to process a command further based on a command setting associated with a mode (e.g., silent mode, vibrate mode, battery saver mode, etc.) of computing device 100. For example, based on the command setting associated with a mode of computing device 100, secure element 106 may determine not to discard all transaction types when computing device 200 is in a standard or regular mode, but to discard specific transaction types when computing device 200 is in battery saver mode (e.g., to reduce power consumption).

In some examples, the transaction configuration may control how secure element 206 determines to process a command further based on a command setting associated with an orientation of computing device 100. For example, based on the command setting associated with an orientation of computing device 100, secure element 106 may determine to discard a command when display 110 is facing downwards (e.g., when the normal vector of display 110 is pointing substantially vertically down).

In any case, based on whether secure element 106 may activate application processor 108 only when doing so is necessary to process a command. For example, responsive to determining that processing the command from vehicle head unit 120 requires activating application processor 108 (“NO” branch of 302), secure element 106 may cause application processor 108 to be activated such that application processor 108 is operating in a high-power state (304). Application processor 108 may then process the command (306). Conversely, responsive to determining that secure element 106 can process the command from vehicle head unit 120 without activating application processor 108 (“YES” branch of 302), secure element 106 may process the command while application processor 108 is operating in a low-power state (308). For example, secure element 106 may discard or otherwise respond to the command.

Aspects of the disclosure include the following examples.

Example 1: A method includes receiving, by a secure element of a computing device, a command from a vehicle; determining, by the secure element, whether the secure element can process the command while an application processor of the computing device is operating in a low-power state based on at least one of a transaction type or a transaction configuration of the secure element; and responsive to determining that the secure element can process the command while the application processor is operating in the low-power state, processing, by the secure element, the command while the application processor is operating in the low-power state.

Example 2: The method of example 1, further includes responsive to determining that the secure element cannot process the command while the application processor is operating in the low-power state, causing, by the secure element, the application processor to switch to operating in a high-power state; and processing, by the application processor, the command.

Example 3: The method of example 2, wherein the secure element includes one or more low-power cores, and wherein the application processor includes one or more high-power cores.

Example 4: The method of any of examples 1 to 3, wherein the command is a request for a digital key stored in the secure element.

Example 5: The method of any of examples 1 to 4, wherein the command is a request from the vehicle to confirm presence of the computing device.

Example 6: The method of any of examples 1 to 5, wherein the transaction configuration includes at least one of a command setting associated with an orientation of the computing device or a command setting associated with a status of the computing device.

Example 7: The method of any of examples 1 to 6, wherein the secure element is configured to communicate with the vehicle via a wireless transport while the application processor of the computing device is operating in the low-power state.

Example 8: The method of any of examples 1 to 7, wherein processing, by the secure element, the command includes discarding, by the secure element, the command.

Example 9: The method of any of examples 1 to 8, wherein processing, by the application processor, the command includes outputting, by the application processor and for display, the command.

Example 10: A computing device includes an an application processor; and a secure element, wherein the secure element is configured to: receive, from a vehicle communicatively coupled to the computing device, a command; determine, based on at least one of a transaction type or a transaction configuration of the secure element, whether the secure element can process the command while the application processor is operating in a low-power state; responsive to determining that the secure element can process the command while the application processor is operating in the low-power state, process the command while the application processor is operating in the low-power state; and responsive to determining that the secure element cannot process the command while the application processor is operating in the low-power state: cause the application processor to switch from operating in the low-power state to operating in a high-power state; and send, to the application processor, at least an indication of the command.

Example 11: The computing device of example 10, wherein the secure element includes one or more low-power cores, and wherein the application processor includes one or more high-power cores.

Example 12: The computing device of example 10 or 11, wherein the command is a request for a digital key stored in the secure element.

Example 13: The computing device of any of examples 10 to 12, wherein the command is a request from the vehicle to confirm presence of the computing device.

Example 14: The computing device of any of examples 10 to 13, wherein the transaction configuration includes at least one of a command setting associated with an orientation of the computing device or a command setting associated with a status of the computing device.

Example 15: The computing device of any of examples 10 to 14, wherein the secure element is configured to communicate with the vehicle via a wireless transport while the application processor of the computing device is operating in the low-power state.

Example 16: The computing device of any of examples 10 to 15, wherein, to process the command, the secure element is configured to discard the command.

Example 17: The computing device of any of examples 11 to 16, wherein, to process the command, the application processor is configured to output, for display, the command.

Example 18: A computer-readable storage medium includes receive, by the one or more secure elements, a command from a vehicle; determine, by the one or more secure elements, whether the one or more secure elements can process the command while the one or more application processors are operating in a low-power state based on at least one of a transaction type or a transaction configuration of the one or more secure elements; and responsive to determining that the one or more secure elements can process the command while the one or more application processors are operating in the low-power state, process, by the one or more secure elements, the command while the one or more application processors are operating in the low-power state.

Example 19: The computer-readable storage medium of example 18, wherein the instructions further cause the one or more application processors and the one or more secure elements to: responsive to determining that the one or more secure elements cannot process the command while the one or more application processors are operating in the low-power state, cause, by the one or more secure elements, the one or more application processors to switch to operating in a high-power state; and process, by the one or more application processors, the command.

Example 20: The computer-readable storage medium of example 19, wherein the one or more secure elements include one or more low-power cores, and wherein the one or more application processors include one or more high-power cores.

Example 21: The computer-readable storage medium of any of example 18 to 20, wherein the command is a request for a digital key stored in the secure element.

Example 22: The computer-readable storage medium of any of examples 18 to 21, wherein the command is a request from the vehicle to confirm presence of the computing device.

Example 23: The computer-readable storage medium of any of examples 18 to 22, wherein the transaction configuration includes at least one of a command setting associated with an orientation of the computing device or a command setting associated with a status of the computing device.

Example 24: The computer-readable storage medium of any of examples 18 to 23, wherein the one or more secure elements are configured to communicate with the vehicle via a wireless transport while the one or more application processors are operating in the low-power state.

Example 25: The computer-readable storage medium of any of examples 18 to 24, wherein processing, by the one or more secure elements, the command includes discarding, by the one or more secure elements, the command.

Example 26: The computer-readable storage medium of any of examples 18 to 25, wherein processing, by the one or more application processors, the command includes outputting, by the one or more application processors and for display, the command.

By way of example, and not limitation, such computer-readable storage media can comprise RAM, ROM, EEPROM, CD-ROM or other optical disk storage, magnetic disk storage, or other magnetic storage devices, flash memory, or any other storage medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage mediums and media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable medium.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

1. A method comprising:
receiving, by a secure element of a computing device, a command from a vehicle;
determining, by the secure element, whether the secure element can process the command while an application processor of the computing device is operating in a low-power state based on at least one of a transaction type or a transaction configuration of the secure element; and
responsive to determining that the secure element can process the command while the application processor is operating in the low-power state, processing, by the secure element, the command while the application processor is operating in the low-power state.

2. The method of claim 1, further comprising:
responsive to determining that the secure element cannot process the command while the application processor is operating in the low-power state, causing, by the secure element, the application processor to switch to operating in a high-power state; and
processing, by the application processor, the command.

3. The method of claim 2, wherein the secure element comprises one or more low-power cores, and wherein the application processor comprises one or more high-power cores.

4. The method of claim 1, wherein the command is a request for a digital key stored in the secure element.

5. The method of claim 1, wherein the command is a request from the vehicle to confirm presence of the computing device.

6. The method of claim 1, wherein the transaction configuration comprises at least one of a command setting associated with an orientation of the computing device or a command setting associated with a status of the computing device.

7. The method of claim 1, wherein the secure element is configured to communicate with the vehicle via a wireless transport while the application processor of the computing device is operating in the low-power state.

8. The method of claim 1, wherein processing, by the secure element, the command comprises discarding, by the secure element, the command.

9. The method of claim 1, wherein processing, by the application processor, the command comprises outputting, by the application processor and for display, the command.

10. A computing device comprising:
an application processor; and
a secure element, wherein the secure element is configured to:
receive, from a vehicle communicatively coupled to the computing device, a command;
determine, based on at least one of a transaction type or a transaction configuration of the secure element, whether the secure element can process the command while the application processor is operating in a low-power state;
responsive to determining that the secure element can process the command while the application processor is operating in the low-power state, process the command while the application processor is operating in the low-power state; and
responsive to determining that the secure element cannot process the command while the application processor is operating in the low-power state:
cause the application processor to switch from operating in the low-power state to operating in a high-power state; and
send, to the application processor, at least an indication of the command.

11. The computing device of claim 10, wherein the secure element comprises one or more low-power cores, and wherein the application processor comprises one or more high-power cores.

12. The computing device of claim 10, wherein the command is a request for a digital key stored in the secure element.

13. The computing device of claim 10, wherein the command is a request from the vehicle to confirm presence of the computing device.

14. The computing device of claim 10, wherein, to process the command, the application processor is configured to output, for display, the command.

15. (canceled)

16. The computing device of claim 10, wherein the transaction configuration comprises at least one of a command setting associated with an orientation of the computing device or a command setting associated with a status of the computing device.

17. A computer-readable storage medium comprising instructions that, when executed, cause a secure element of a computing device to:
receive, from a vehicle communicatively coupled to the computing device, a command;
determine, based on at least one of a transaction type or a transaction configuration of a secure element of the computing device, whether the secure element can process the command while an application processor of the computing device is operating in a low-power state; and
responsive to determining that the secure element can process the command while the application processor is operating in the low-power state, process the command while the application processor is operating in the low-power state

18. The computer-readable storage medium of claim 17, wherein the instructions further cause the secure element of the computing device to:
responsive to determining that the secure element cannot process the command while the application processor is operating in the low-power state:
cause the application processor to switch from operating in the low-power state to operating in a high-power state; and
send, to the application processor, at least an indication of the command.

19. The computer-readable storage medium of claim 17, wherein the secure element comprises one or more low-power cores, and wherein the application processor comprises one or more high-power cores.

20. The computer-readable storage medium of claim 17, wherein the command is a request for a digital key stored in the secure element.

21. The computer-readable storage medium of claim 17, wherein the command is a request from the vehicle to confirm presence of the computing device.
